(19) United States
(12) Patent Application Publication
(10) Pub. No.: US 2010/0104898 A1
(43) Pub. Date: Apr. 29, 2010

(54) FUEL CELL SYSTEM WITH A RECIRCULATION STRAND

(75) Inventors: Norbert Guenther, Ribnitz Damgarten (DE); Andreas Reinert, Dresden (DE); Stefan Kaeding, Zerrenthin (DE); Björn Erik Mai, Dresden (DE)

Correspondence Address: FITCH, EVEN, TABIN & FLANNERY, P. O. BOX 18415, WASHINGTON, DC, 20036, US

(73) Assignee: ENERDAY GMBH, Neubrandenburg (DE)

(21) Appl. No.: 12/529,993

(22) PCT Filed: Mar. 13, 2008
(86) PCT No.: PCT/DE2008/000436

§ 371 Date: Sep. 4, 2009

(30) Foreign Application Priority Data
Mar. 16, 2007 (DE) 10 2007 012 762.8

(51) Int. Cl. H01M 8/06

(52) U.S. Cl. 429/17; 429/19

(57) ABSTRACT

The invention relates to a fuel cell system comprising a reformer for generating a reformate from a fuel and an oxidising agent, a fuel cell for converting the reformate into a depleted reformate and electric energy, and a recirculation conduit for partly returning the depleted reformate to the reformer. In this connection the invention is advantageously characterised in that a delivery device is provided by means of which the fuel as well as the depleted reformate from the recirculation conduit are supplyable to the reformer. The invention further relates to a method for operating such a fuel cell system.

The invention relates to a fuel cell system comprising a reformer for generating a reformate of fuel and oxidising agent, a fuel cell for converting the reformate into a depleted reformate and electric energy, and a recirculation conduit for partly returning the depleted reformate to the reformer.

In addition the invention relates to a method for operating a fuel cell system comprising the steps of generating a reformate from a fuel and an oxidising agent by means of a reformer; of converting the reformate into a depleted reformate and electric energy by means of a fuel cell; and of partly returning the depleted reformate to the reformer via a recirculation conduit.

Fuel cell systems serve the conversion of chemical energy into electric energy in a commonly known manner. Fuel cell systems have to be capable of processing fuels common in practice. Since hydrogen and oxygen are converted in a fuel cell the fuel used has to be processed so that the gas supplied to the anode of the fuel cell has the highest possible hydrogen content. On the side of the cathode in most cases atmospheric oxygen is supplied to the fuel cell. For this purpose a reformer is supplied with a fuel and an oxidising agent, preferably air. In the reformer then a conversion of the fuel together with the oxygen will take place in which case preferably the method the partial oxidation is carried out.

In the EP 1 557 896 A1 a fuel cell system having the features of the preamble of claim 1 is disclosed. In this fuel cell system a reformate gas discharged from a fuel cell on an outlet side is returned to a reformer. Said system, however, has a complex design.

It is therefore the object of the present invention to provide a possibility to provide a fuel cell system which has a relatively simple design and can therefore be manufactured in a cost-effective way.

Said object is solved by the features of the independent claims.

Advantageous embodiments and further developments of the invention will become obvious from the dependent claims.

The fuel cell system according to the invention is based on the generic state of the art in that a delivery device is provided by means of which the fuel as well as the depleted reformate from the recirculation conduit are supplyable to the reformer. With the delivery device which supplies the fuel as well as the depleted reformate to the reformer other delivery devices can be dispensed with. In addition such a construction also enables a simplified control since with an increase of the delivery rate of the delivery device the fuel delivery rate as well as the delivery rate of the depleted reformate are automatically increased so that in case of a change of the delivery rate the individual conduits do not necessarily have to be adjusted with respect to each other. The delivery rate of the returned depleted reformate is therefore controllable via the delivery rate of the supplied fuel.

In addition it is advantageous that a respective flow control valve is provided upstream of the delivery device to independently control the supply of fuel and depleted reformate to the delivery device. This configuration enables an adjustment of the ratio of the fuel to the recirculation flow by varying the two valve positions relative to each other and by varying the rotational speed of the delivery device. This circuitry therefore offers the advantage that a high flexibility with respect to the adjustment of the gas composition in the reformer can be achieved whereby a high flexibility of the fuel cell system with respect to the reaction to load changes can be achieved. Since this ratio also has an influence on the temperature of the reformer it may also be operated in a desired temperature range by means of the adjustment. Furthermore the provision of separate servo valves is more cost-effective than the provision of separate delivery devices in each conduit.

The fuel cell system according to the invention may, in addition, be further developed so that a heat exchanger for cooling of the depleted reformate is provided in the recirculation conduit. Without said heat exchanger the components in the recirculation conduit such as, for example, the valve or the delivery device would have to be designed for temperatures of up to 850° C. which would give rise to a significant increase in costs for the system architecture and render it difficult to find such components at all. Furthermore high operating temperatures lead to a high wear of the mechanical components. This problem can be solved by cooling the recirculation flow so that the recirculation flow is cooled to, for example, 150° C. to enable the use of normal components. The normal components may then be operated at relatively moderate temperatures.

In this connection it may advantageously be contemplated that an oxidising agent conduit guiding the oxidising agent to the reformer, to the fuel cell or to an afterburner is lead through the heat exchanger. In this way a media flow already present in the fuel cell system may be used to cool the returned depleted reformate. Additional fans for cooling of recirculation flow can therefore be dispensed with.

In addition the invention provides a method for controlling such a fuel cell system.

Within the framework of the method the same may advantageously be characterised by closing the flow control valve in the recirculation conduit during the start-up or shutdown of the fuel cell system. Owing to this measure the recirculation conduit can be deactivated during the start-up of the fuel cell system during which insufficient depleted reformate is available or during the shutdown of the fuel cell system so that advantageous conditions can be provided for said operating states.

A preferred embodiment of the invention will be described below by way of example with reference to the Figure in which:

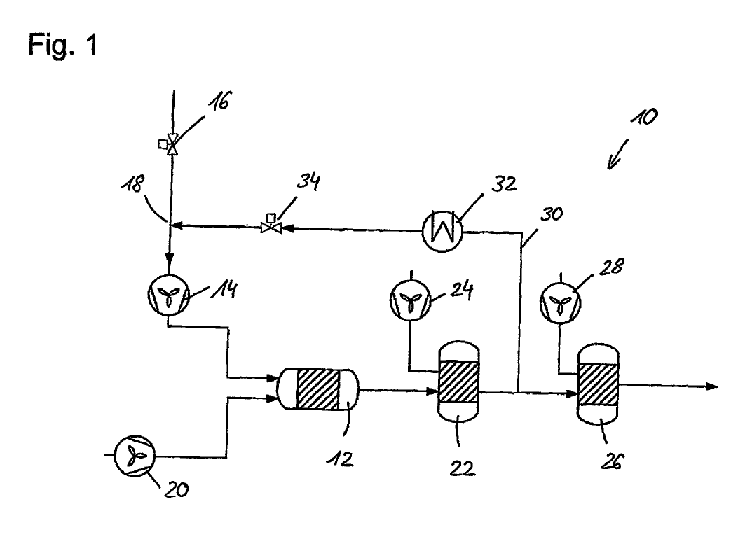

FIG. 1 is a schematic representation of the fuel cell system according to the invention.

FIG. 1 shows a schematic representation of the fuel cell systems 10 according to the invention. The fuel cell system 10 comprises a reformer 12 to which a fuel and a depleted reformate to be explained below are supplyable by means of a delivery device 14. As a delivery device 14 a fan or all suitable types of pumps such as, for example, rotary vane pumps for gases, may be used. For controlling the supply of the fuel a flow control valve 16 is provided upstream of the delivery device 14 and upstream of a merging position 18 in which the returned depleted reformate is introduced. As fuel types diesel fuel, gasoline, biogas, natural gas and other types of fuel known from the state of the art qualify, the fuel preferably being a gas in the present embodiment.

Above that the reformer 12 is supplied with oxidising agent by means of a reformer fan 20. The reformer 12 preferably converts the substances supplied by the delivery device 14 and the reformer fan 20 into a reformate supplyable to the fuel cell 22 under a partial oxidation. As an alternative to the fuel cell 22 a fuel cell stack may be provided. The reformate is a hydrogenous gas which is converted into electric current, heat and depleted reformate with the aid of cathode air delivered by a fuel cell fan 24 in the fuel cell 22. The depleted reformate discharged on the outlet side of the fuel cell 22 is divided into two conduits. A part of the depleted anode waste gas is supplied to an afterburner 26 to which an afterburner fan 28 is allocated. In the afterburner 26 a conversion of the depleted reformate together with air delivered by the afterburner fan 28 to a combustion waste gas containing hardly any contaminants takes place. The other part of the depleted reformate is first passed through a heat exchanger 32 or a reformate cooler via a recirculation conduit. 30. The heat exchanger 32 cools the depleted reformate to be returned to, for example, 150° C. Here the recirculation flow may advantageously be cooled by a media flow already present in the fuel cell system 10 using the heat exchanger 32. In this case, for example, the media flows sucked in by the reformer fan 20, the fuel cell fan 24 and/or the afterburner fan 28 qualify as media flows. Alternatively it is also possible to provide a fan for removing the heat energy from the heat exchanger 32. Thereafter the recirculation flow passes a flow control valve 34 for a flow control of the recirculation flow. The recirculation flow is then mixed with the fuel at the merging position 18 and supplied to the delivery device 14. At the same time the delivery device 14 sucks in the fuel and the depleted reformate supplied via the recirculation conduit 30. With such a recirculation a higher system efficiency can be achieved since the energy of the depleted reformate is converted even more completely so that more electric energy can be extracted with the same amount of fuel as compared to systems without a recirculation conduit 30 so that the electric efficiency of the system is increased. The adjustment or control of the flow control valves 16 and 34 as well as of the delivery device 14 is realised by suitable control algorithms stored in an electronic control unit. The electronic control unit is preferably a micro controller connected to at least the delivery device 14, the flow control valve 16, the reformer fan 20, the fuel cell fan 24, the afterburner fan 28 as well as the flow control valve 34.

As an alternative to the embodiment described above corresponding pumps for delivering gas may be provided instead of the reformer fan 20, the fuel cell fan 24 and the afterburner fan 28.

The features of the invention disclosed in the above description, in the drawings as well as in the claims may be important for the realisation of the invention individually as well as in any combination.

### LIST OF NUMERALS

10 fuel cell system
12 reformer
14 delivery device
16 flow control valve
18 merging position
20 reformer fan
22 fuel cell
24 fuel cell fan
26 afterburner
28 afterburner fan
30 recirculation conduit
32 heat exchanger
34 flow control valve

1. A fuel cell system comprising a reformer for generating a reformate from a fuel and an oxidising agent, a fuel cell for converting the reformate into a depleted reformate and electric energy, and a recirculation conduit for partly returning the depleted reformate to the reformer, characterised in that a delivery device is provided by means of which the fuel as well as the depleted reformate from the recirculation conduit are supplyable to the reformer.

2. The fuel cell system according to of claim 1, characterised in that a respective flow control valve is provided upstream of the delivery device for independently controlling the supply of fuel and depleted reformate to the delivery device.

3. The fuel cell system according to one of the preceding of claim 1, characterised in that a heat exchanger for cooling the depleted reformate is provided in the recirculation conduit.

4. The fuel cell system according to of claim 4, characterised in that an oxidising agent conduit supplying oxidising agent to the reformer, the fuel cell or an afterburner is lead through the heat exchanger.

5. A method for operating a fuel cell system comprising the steps of:
generating a reformate from a fuel and an oxidising agent by means of a reformer;
converting the reformate into a depleted reformate and electric energy by means of a fuel cell; and
partly returning the depleted reformate to the reformer via a recirculation conduit,
characterised by the operation of a delivery device to supply the fuel as well as the depleted reformate from the recirculation conduit to the reformer.

6. The method of claim 5, characterised by the control of the flow of fuel and the control of the flow of depleted reformate to the delivery device by means of a flow control valve, respectively.

7. The method of claim 5, characterised by the cooling of the depleted reformate in the recirculation conduit means of a heat exchanger.

8. The method according to of claim 7, characterised by the cooling of the depleted reformate in the recirculation conduit by passing oxidising agent which is supplied to the reformer, the fuel cell or an afterburner through the heat exchanger.

9. The method of claim 6, characterised by a closing of the flow control valve in the recirculation conduit during the start-up or the shutdown of the fuel cell system.
